(19) United States
(12) Patent Application Publication
(10) Pub. No.: US 2017/0173464 A1
(43) Pub. Date: Jun. 22, 2017

(54) VIDEO GAME PROCESSING PROGRAM, AND VIDEO GAME PROCESSING SYSTEM

(71) Applicant: KABUSHIKI KAISHA SQUARE ENIX (also trading as SQUARE ENIX CO., LTD.), Tokyo (JP)

(72) Inventor: Jin FUJISAWA, Tokyo (JP)

(73) Assignee: KABUSHIKI KAISHA SQUARE ENIX (also trading as SQUARE ENIX CO., LTD.), Tokyo (JP)

(21) Appl. No.: 15/388,189

(22) Filed: Dec. 22, 2016

(30) Foreign Application Priority Data
Dec. 22, 2015 (JP) 2015-250379

(51) Int. Cl. A63F 13/40; A63F 13/30; A63F 13/45; H04L 29/06; A63F 13/25

(52) U.S. Cl. CPC A63F 13/40; H04L 67/38; A63F 13/25; A63F 13/45; A63F 13/30

(57) ABSTRACT

A non-transitory computer-readable medium including a video game processing program product for causing a user terminal to realize functions to control progress of a video game in response to an operation of a user is provided. The functions include: a registering function configured to register an event in a predetermined storage region when a reserving request for the event is received, the event occurring in the video game; a controlling function configured to control the progress of the video game in a case where the event is registered; and an executing function configured to carry out the event when an execution request for the event registered in the predetermined storage region is received. The controlling function may include a function configured to control the progress of the video game as the registered event did not occur or the event was terminated.

### CROSS-REFERENCE TO RELATED APPLICATION

The present application relates to subject matter contained in Japanese Patent Application No. 2015-250379 field on Dec. 22, 2015, the disclosure of which is expressly incorporated herein by reference in its entirety.

### BACKGROUND OF THE INVENTION

1. Field of the Invention

At least one of embodiments according to the present invention relates to a non-transitory computer-readable medium including a video game processing program and a video game processing system for causing a user terminal to realize functions to control progress of a video game in response to an operation of a user.

2. Description of the Related Art

Heretofore, in a field of a video game, there is a system that is configured so that various kinds of events that occurred can be skipped.

In such a system, for example, there is a system configured so that a movie that is reproduced together with start of a battle can be skipped at arbitrary timing (see Japanese Patent Application Publication No. 2015-037582).

The conventional system allows various kinds of events, which occur in a video game, to skip, whereby a person who has a sufficient play time is caused to enjoy an event, and a person who has a little play time is caused to omit an event appropriately. Thus, the conventional system has a side to cause how to enjoy the video game to have the degree of freedom. However, in the conventional system, there has been a case where interest in the video game is lowered by allowing a user to skip an event. Namely, for example, in a case where a video game is configured so that all events constituting the video game can be skipped, there has been a case where the interest in the video game is not be communicated to the user. On the other hand, in a case where skip of an event is limited to an undue degree, there has been a case where a load required for the user becomes larger.

### SUMMARY OF THE INVENTION

It is an object of at least one of embodiments according to the present invention to solve the problem described above, and to improve the degree of freedom regarding how to enjoy a video game.

According to one non-limiting aspect of the present invention, there is provided a non-transitory computer-readable medium including a video game processing program product for causing a user terminal to realize functions to control progress of a video game in response to an operation of a user.

The functions include a registering function configured to register an event in a predetermined storage region when a reserving request for the event is received, the event occurring in the video game.

The functions also include a controlling function configured to control the progress of the video game in a case where the event is registered.

The functions also include an executing function configured to carry out the event when an execution request for the event registered in the predetermined storage region is received.

According to another non-limiting aspect of the present invention, there is provided a non-transitory computer-readable medium including a video game processing program for causing a server to realize functions to control progress of a video game in response to an operation of a user.

The functions include a registering function configured to register an event in a predetermined storage region when a reserving request for the event is received, the event occurring in the video game.

The functions also include a controlling function configured to control progress of the video game in a case where the event is registered.

The functions also include an executing function configured to carry out the event when an execution request for the event registered in the predetermined storage region is received.

According to still another non-limiting aspect of the present invention, there is provided a video game processing system for controlling progress of a video game in response to an operation of a user, the video game processing system including a communication network, a server.

The video game processing system includes a registering section configured to register an event in a predetermined storage region when a reserving request for the event is received, the event occurring in the video game.

The video game processing system also includes a controlling section configured to control the progress of the video game in a case where the event is registered.

The video game processing system also includes an executing section configured to carry out the event when an execution request for the event registered in the predetermined storage region is received.

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a video game processing system corresponding to at least one of embodiments according to the present invention.

FIG. 2 is a block diagram showing a configuration of a video game processing server corresponding to at least one of the embodiments according to the present invention.

FIG. 3 is a flowchart showing an example of game processing corresponding to at least one of the embodiments according to the present invention.

FIG. 4 is a flowchart showing an example of an operation of a server side in the game processing corresponding to at least one of the embodiments according to the present invention.

FIG. 5 is a flowchart showing an example of an operation of a terminal side in the game processing corresponding to at least one of the embodiments according to the present invention.

FIG. 6 is a block diagram showing a configuration of a user terminal corresponding to at least one of the embodiments according to the present invention.

FIG. 7 is a flowchart showing an example of the game processing corresponding to at least one of the embodiments according to the present invention.

FIG. 8 is a block diagram showing a configuration of the user terminal corresponding to at least one of the embodiments according to the present invention.

FIG. 9 is a flowchart showing an example of the game processing corresponding to at least one of the embodiments according to the present invention.

FIG. 10 is a block diagram showing a configuration of the user terminal corresponding to at least one of the embodiments according to the present invention.

FIG. 11 is a flowchart showing an example of the game processing corresponding to at least one of the embodiments according to the present invention.

FIG. 12 is a block diagram showing a configuration of the user terminal corresponding to at least one of the embodiments according to the present invention.

FIG. 13 is a flowchart showing an example of the game processing corresponding to at least one of the embodiments according to the present invention.

FIG. 14 is a block diagram showing a configuration of the user terminal corresponding to at least one of the embodiments according to the present invention.

FIG. 15 is an explanatory drawing for explaining an example of a storage state of information corresponding to at least one of the embodiments according to the present invention.

FIG. 16 is an explanatory drawing for explaining an example of a game screen corresponding to at least one of the embodiments according to the present invention.

FIG. 17 is a flowchart showing an example of the game processing corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like did not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like did not occur in the content of the processing.

### First Embodiment

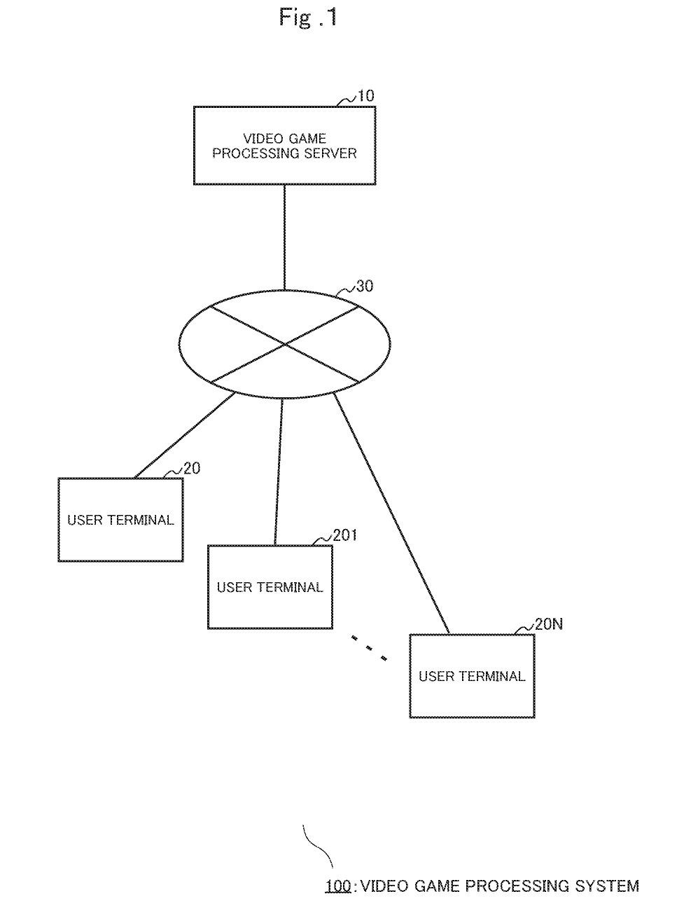

FIG. 1 is a block diagram showing an example of a configuration of a video game processing system 100 according to one embodiment of the present invention. As shown in FIG. 1, the video game processing system 100 includes a video game processing server 10 (hereinafter, referred to as a “server 10”) and user terminals 20 and 201 to 20N (“N” is an arbitrary integer) respectively used by users of the video game processing system 100. In this regard, the configuration of the video game processing system 100 is not limited to this configuration. The video game processing system 100 may be configured so that the plurality of users uses a single user terminal, or may be configured so as to include a plurality of servers.

Each of the server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The video game processing system 100 includes the server 10 and the plurality of user terminals 20 and 201 to 20N, whereby various kinds of functions for carrying out various kinds of processing in response to an operation of the user is realized.

The server 10 is managed by, an administrator of the video game processing system 100, and has various kinds of functions to provide information regarding various kinds of processing to the plurality of user terminals 20 and 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processing as a computer, such as a control section and a communicating section. However, its explanation herein is omitted. Further, in the video game processing system 100, it is preferable that the server 10 manages various kinds of information from a point of view to reduce a processing load on each of the plurality of user terminals 20 and 201 to 20N. However, a storing section for storing various kinds of information may include a storage region in a state that the server 10 can access the storage region. For example, the server 10 may be configured so as to be provided with a dedicated storage region outside the server 10.

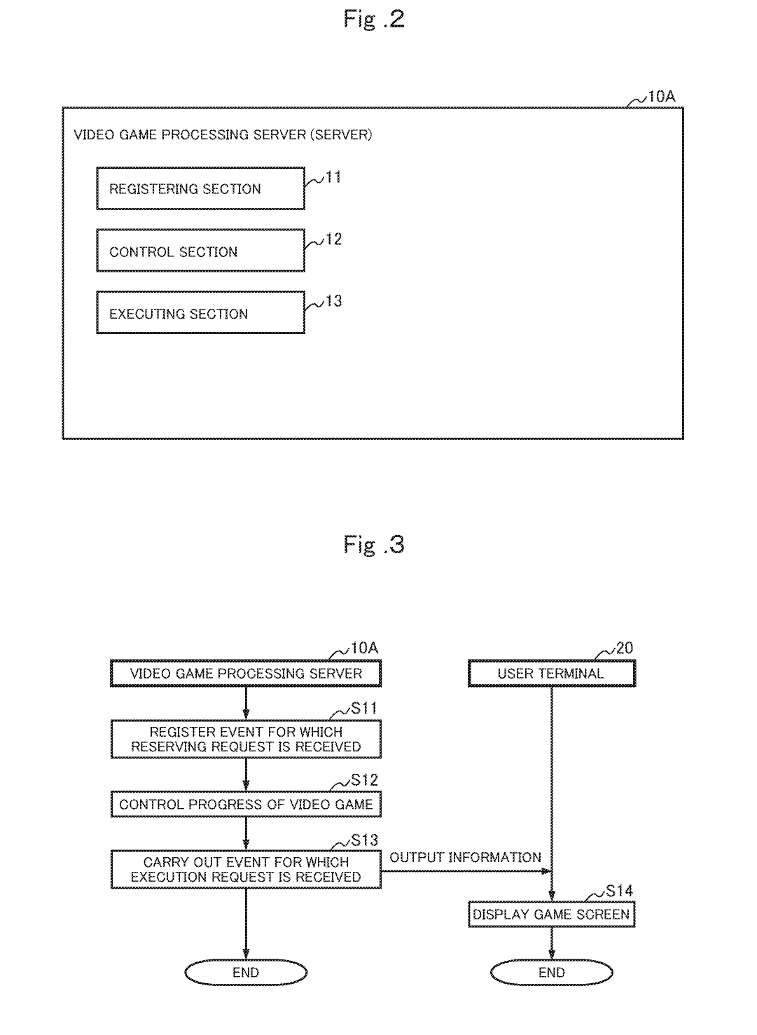

FIG. 2 is a block diagram showing a configuration of a server 10A, which is an example of the configuration of the server 10. As shown in FIG. 2, the server 10A at least includes a registering section 11, a control section 12, and an executing section 13.

The registering section 11 has a function to register, when a reserving request for an event that occurred in a video game is received, the event in a predetermined storage region.

Here, the event means an instance or occurrence that occurred in the video game. The configuration of the event is not limited particularly. The event may be one for which a user operation can be received (for example, fight), or one for which a user operation cannot be received (for example, moving picture (animation) reproduction). In this regard, the configuration to cause an event to occur is not limited particularly. However, it is preferable that it is a configuration in which the event occurs in accordance with progress of the video game.

Further, the reserving request means a command to instruct to reserve the event. The configuration to receive a reserving request is not limited particularly so long as the user can recognize the event. As examples of the configuration to receive a reserving request, there are a configuration to determine that a predetermined operation input by the user is a reserving request and a configuration to determine that satisfying a predetermined condition is a reserving request. In this regard, the event registered in accordance with the reserving request is expressed as “reserve” herein because the event is to be registered in a state that can be carried out later.

The control section 12 has a function to control progress of the video game on the basis of a situation that the event is registered.

Here, the configuration to control progress of the video game on the basis of a situation that the event is registered is not limited particularly so long as it is a configuration to reflect a result that the event is registered to subsequent processes. As examples of such a configuration, there are a configuration in which a game screen representing that an event is registered is displayed and a configuration in which an event is completed in a case where the event is registered, and a story thereafter proceeds.

The executing section 13 has a function to carry out the event when an execution request for the event registered in the predetermined storage region is received.

Here, the configuration to receive an execution request for an event is not limited particularly so long as it is a configuration that the user can recognize the event. As an example of such a configuration, there is a configuration in which a list of the registered events is displayed and selection by the user is received.

Further, the phrase “carry out an event” means that a user is caused to experience an event. Namely, for example, in a case where an event is moving picture reproduction, reproducing a moving picture corresponding to the event corresponds to execution of the event. Further, in a case where an event is a fight against an enemy character, causing the fight to proceed in response to an operation of the user corresponds to execution of the event. In this regard, the event may be configured so that the event is divided into a plurality of phases including execution (for example, occurrence, execution, and termination) and only a portion of the execution can be reserved.

Each of the plurality of user terminals 20, 201 to 20N is managed by a user, and is configured by a communication terminal, such as a cellular phone terminal, a PDA (Personal Digital Assistants), a mobile game device, and a so-called wearable divide, by which the user can play a network delivery type game, for example. In this regard, a configuration of the user terminal that the video game processing system 100 can include is not limited to the examples described above. It may be a configuration in which the user can recognize the video game. As other examples of the user terminal, there are a combination of various kinds of communication terminals, a personal computer, and a stationary game device.

Further, each of the plurality of user terminals 20, 201 to 20N is connected to the communication network 30, and includes hardware (for example, a display device for displaying a browser screen and a game screen according to a coordinate and the like) and software for carrying out various kinds of processing by communicating with the server 10. In this regard, each of the plurality of user terminals 20, 201 to 20N may be configured so as to be capable of directly communicating with each other without the server 10.

Next, an operation of the video game processing system 100 (hereinafter, referred to as the “system 100”) according to the present embodiment will be described.

FIG. 3 is a flowchart showing an example of game processing carried out by the system 100. In the game processing according to the present embodiment, processing related to registration of an event is carried out. Hereinafter, the case where the server 10A and the user terminal 20 (hereinafter, referred to also as a “the terminal 20”) carry out the game processing will be described as an example.

The game processing is started when an event occurs in the video game, for example. Hereinafter, the case where an event that can be reserved occurs and the server 10A receives a reserving request for the event will be described as an example.

In the game processing, the server 10A first registers an event for which a reserving request is received (Step S11). In the present embodiment, the server 10A registers information necessary to carry out the event that occurred later in a predetermined storage region.

When the event is registered, the server 10A controls progress of the video game on the basis of a situation that the event is registered (Step S12). In the present embodiment, the server 10A informs the user that the event is registered, and carries out processing according to a status of the video game.

In a case where an execution request for the event is received while controlling progress of the video game, the server 10A carries out the event for which the execution request is received (Step S13). In the present embodiment, the server 10A carries out the registered event that is specified by the user. In this regard, in the present embodiment, the server 10A transmits information for outputting a game screen regarding the event (hereinafter, referred to as “output information”) to the terminal 20, and causes the display device included in the terminal 20 to display the game screen on a display screen thereof.

Here, the game screen means a screen representing a virtual space (or a game space). In this regard, in the present embodiment, various kinds of elements constituting the game screen may be called as an image. A configuration of the game screen is not limited particularly so long as it is a configuration in which the user can recognize a status of the video game.

Further, the phrase “display the game screen on the display screen of the display device” means that the game screen is outputted onto the display device included in the user terminal 20 or the like by means of communication using the communication network 30. As an example of a configuration to cause the display device to display the game screen, there is a configuration in which information generated at the server side (output information”) is transmitted to the terminal side. In this regard, a configuration of the output information is not limited particularly. For example, it may be information in which an image is compressed, or information for causing the terminal side to generate an image. As an example of the information in which the image is compressed, there is one used in a cloud game (for example, MPEG). Further, as information for generating an image at the terminal side, there is one used in an online game (for example, positional information of an object).

The terminal 20 causes the display device included therein to display a game screen on the display screen on the basis of the output information received from the server 10A (Step S14), and terminates the processing herein.

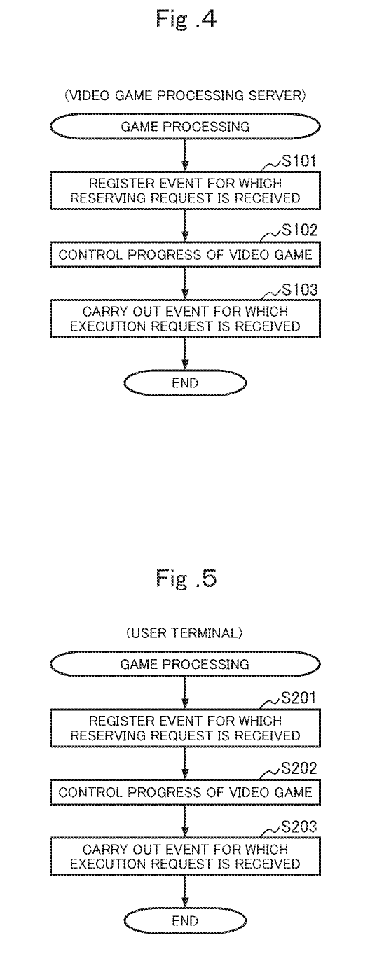

FIG. 4 is a flowchart showing an example of an operation of the server 10A side in the game processing. Here, an operation of the server 10A in the system 100 will be described again.

In the game processing, the server 10A first registers an event for which a reserving request is received (Step S101), and controls progress of the video game (Step S102). In the present embodiment, the server 10A appropriately receive information regarding a user operation (operation related information) from the terminal 20, and controls progress of the video game.

In a case where an execution request for the registered event is received while controlling progress of the video game, the server 10A carries out the event for which the execution request is received (Step S103). In the present embodiment, the server 10A generates information regarding execution of the event, and transmits the generated information to the terminal 20.

FIG. 5 is a flowchart showing an example of an operation of the terminal 20 side in a case where the terminal 20 carries out the game processing. Hereinafter, the case where the terminal 20 carries out the game processing by a single body will be described as an example. In this regard, a configuration of the terminal 20 includes similar functions to the configuration of the server 10 except that the terminal 20 receives various kinds of information from the server 10. For this reason, its description is omitted from a point of view to avoid repeated explanation.

In the game processing, the terminal 20 first registers an event for which a reserving request is received (Step S201); controls progress of the video game (Step S202); and carries out, when an execution request for the event is received, the event for which the execution request is received (Step S203). In the present embodiment, the terminal 20 stores the registered event in a predetermined storage region, and reads out information for carrying out the event from the predetermined storage region in a case where the execution request including identification information of the event is received.

As explained above, as one side of the first embodiment, the server 10A provided with the functions to control progress of the video game in response to an operation of the user is configured so as to include the registering section 11, the control section 12, and the executing section 13. Thus, when a reserving request for an event that occurred in the video game is received, the event is registered in a predetermined storage region; progress of the video game is controlled on the basis of a situation that the event is registered; and the event is carried out when an execution request for the event registered in the predetermined storage region is received. Therefore, it is possible to improve the degree of freedom regarding how to enjoy a video game.

Namely, the user does not skip an event that occurred in the video game simply, but can reserve the event (that is, register the event so that the event can be carried out later). Therefore, for example, the user can reserve an event when he or she has no time, and play the reserved event when the user will get a time. This makes it possible to enhance the degree of freedom regarding a play form of the video game.

### Second Embodiment

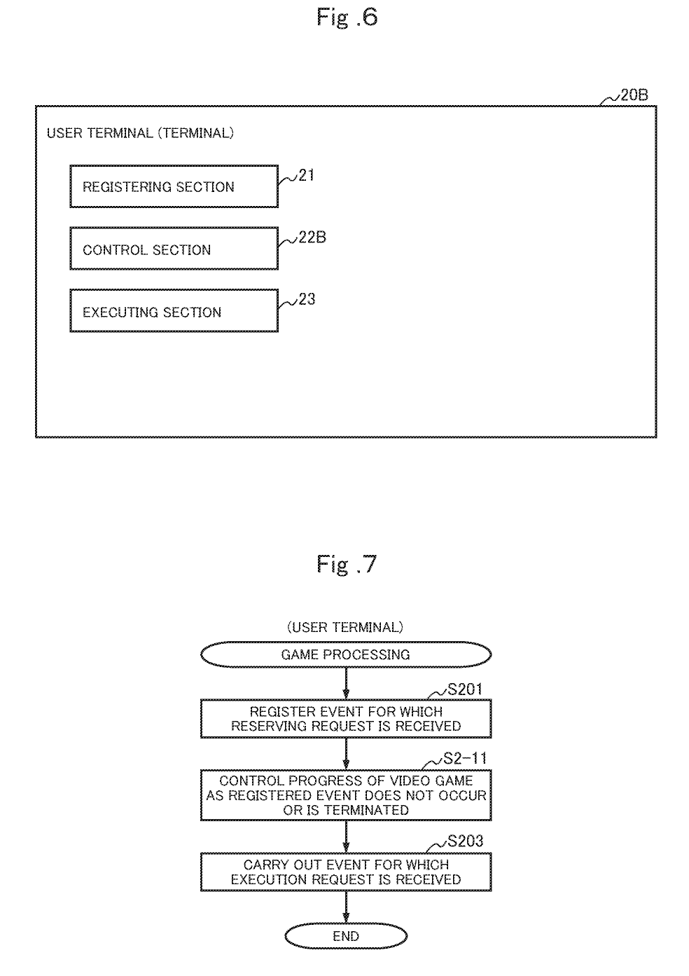

FIG. 6 is a block diagram showing a configuration of a user terminal 20B (hereinafter, referred to as a “terminal 20B”), which is an example of the user terminal 20. In the present embodiment, the terminal 20B at least includes a registering section 21, a control section 22B, and an executing section 23.

The control section 22B has a function to control progress of a video game as the registered event did not occur (or unoccur) or the event was terminated (or completed).

Here, the phrase “control progress of the video game as the registered event did not occur” means that the event that occurred is caused not to influence on progress of the video game. Namely, in a case where an occurrence condition of an event is satisfied, a predetermined event occurs and this event is then registered, the control section 22B sets up a status of the video game to a state before occurrence of the event, and controls progress of the video game thereafter. In this regard, in this case, the terminal 20B may be configured so as to change the occurrence condition of the registered event from one before registration to an execution request for the registered event.

Further, the configuration to control progress of the video game as the event is terminated is not limited particularly. However, it is preferable that it is a configuration so that the user wants to play a reserved event. As an example of such a configuration, there is a configuration in which when an event is registered, it is determined that the event is succeeded, and progress of the video game thereafter is controlled as the user does not obtain an in-game element that the user is allowed to obtain in the event.

Further, the terminal 20B may be configured so that whether to unoccur or terminate the registered event is determined in accordance with a predetermined rule. The terminal 20B may be configured so as to adopt only one of them. In this regard, the configuration to determine whether to unoccur or terminate the registered event in accordance with the predetermined rule is not limited particularly. For example, the terminal 20B may be configured so that “treatment in a case where an event is registered” is contained in information regarding the event and whether to unoccur or terminate the registered event is determined by referring to the information when a registration request for the event is received.

FIG. 7 is a flowchart showing an example of the game processing carried out by the terminal 20. Hereinafter, an operation of the terminal 20B will be described as an example. In this regard, an operation of the terminal 20B with the server 10 is omitted from a point of view to avoid repeated explanation.

When an event that occurred is registered, the terminal 208 controls progress of the video game as a registered event unoccurs or is terminated (Step S2-11). In the present embodiment, in a case where the event is a fight, the terminal 20B controls progress of the video game as unoccurrence of an event. Further, in a case where the event is moving picture reproduction, the terminal 208 controls progress of the video game as the moving picture reproduction is terminated.

As explained above, as one side of the second embodiment, the user terminal 20B is configured so as to include the control section 22B. Thus, progress of the video game is controlled as the registered event did not occur or the event was terminated. Therefore, it is possible to control progress of the video game in a case where the event that occurred is registered.

### Third Embodiment

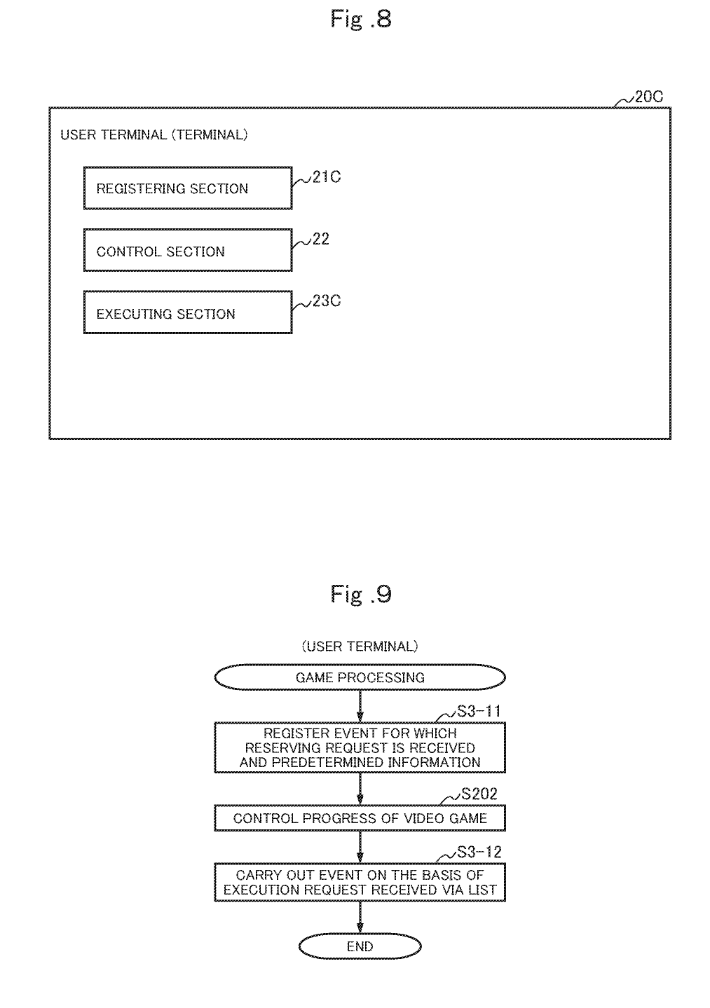

FIG. 8 is a block diagram showing a configuration of a user terminal 20C (hereinafter, referred to as a “terminal 20C”), which is an example of the user terminal 20. In the present embodiment, the terminal 20C at least includes a registering section 21C, a control section 22, an executing section 23C.

The registering section 21C has a function to register an event and predetermined information in a predetermined storage region so as to be associated with each other.

Here, the content of the predetermined information is not limited particularly. However, it is preferable to be one by which the user can be caused to recognize a registered event. As an example of the predetermined information, there is information regarding occurrence of the event, such as date and time of the occurrence of the event (occurrence related information). As other example of the information regarding occurrence of the event, there is information that is determined in accordance with a predetermined rule at the time of the occurrence of the event (for example, a level of an enemy character, a capturing probability of the enemy character, a fight start status and the like). In this regard, the event herein means information regarding the event, such as a name of the event and the content of the event.

The executing section 23C has a function to refer to the predetermined storage region to carry out the event on the basis of an execution request received via a list that is displayed.

Here, the configuration to receive the execution request for the event via the list is not limited particularly. However, it is preferable that it is a configuration in which the user can recognize the content of an event and input an execution request for the event. As an example of such a configuration, there is a configuration in which a table of the registered events containing an event name and date and time of occurrence of the event is displayed as the list, and when the user specifies an event name, it is determined to receive an execution request for the event corresponding to the specified event name.

FIG. 9 is a flowchart showing an example of the game processing carried out by the terminal 20. Hereinafter, an operation of the terminal 20C will be described as an example. In this regard, an operation of the terminal 20C with the server 10 is omitted from a point of view to avoid repeated explanation.

When a reserving request for an event that occurred is received, the terminal 20C registers an event for which a reserving request is received and predetermined information (Step S3-11). In the present embodiment, the terminal 20C registers information regarding the event and date and time of the occurrence of the event in a predetermined storage region so as to be associated with each other.

When the event is registered and progress of the video game is controlled, the terminal 20C carries out the event on the basis of the execution request received via the list (Step S3-12). In the present embodiment, the terminal 20C causes the display device to display the list representing the registered events in response to a user operation, and carries out processing to carry out the event specified by the user.

As explained above, as one side of the third embodiment, the user terminal 20C is configured so as to include the registering section 21C and the executing section 23C. Thus, the event and the predetermined information are registered in the predetermined storage region so as to be associated with each other, and the event is carried out on the basis of the execution request received via the list displayed by referring to the predetermined storage region. Therefore, it is possible to enhance the degree of freedom regarding a method of carrying out the registered events. Namely, since the user is allowed to select an event, which the user wants to carry out, from the table of the registered events, this makes it possible to improve the degree of freedom for the user.

In this regard, the case where the configuration of the list is not limited particularly has been explained in the example of the embodiment described above. However, the terminal 20C may be configured so that when the execution request for the event is received, a certain restriction is imposed on the user. As an example of such a configuration, there is a configuration in which the user is requested to carry out the events in order defined on the basis of the information regarding the events (for example, a registration order of the events).

### Fourth Embodiment

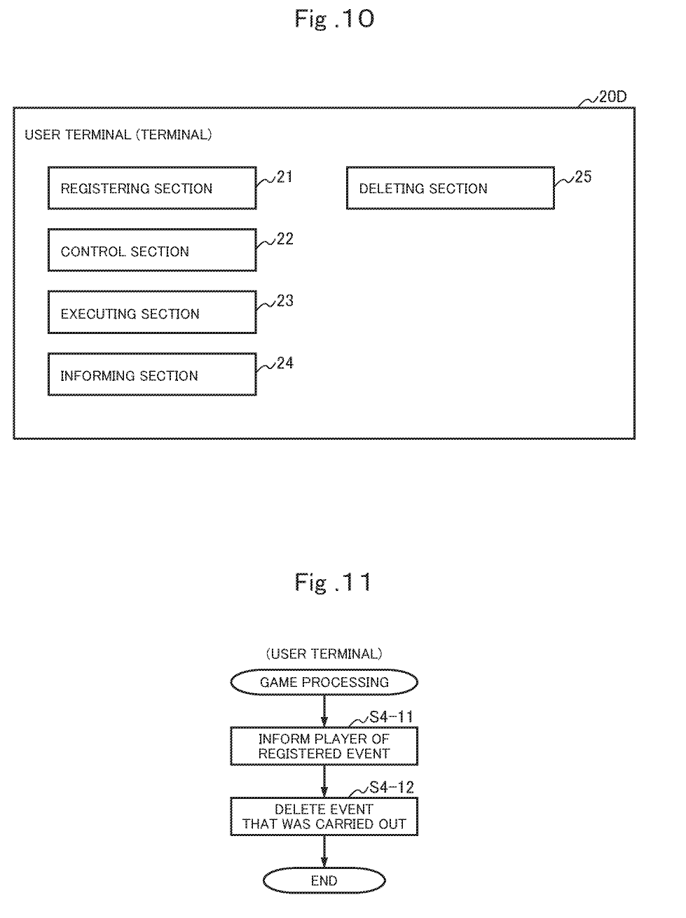

FIG. 10 is a block diagram showing a configuration of a user terminal 20D (hereinafter, referred to as a “terminal 20D”), which is an example of the user terminal 20. In the present embodiment, the terminal 20D at least includes a registering section 21, a control section 22, an executing section 23, an informing section 24, and a deleting section 25.

The informing section 24 has a function to inform a player (that is, a user of the terminal 20D) of at least one event among a predetermined number of events in a case where the number of registered events is the predetermined number.

Here, the configuration of the predetermined number is not limited particularly. The predetermined number may be one, or a registerable upper limit number. Namely, in a case where only the predetermined number of events is registered, the informing section 24 informs the player of existence of the registered event regardless of an operation of the player.

Further, the phase “inform the player of the event” means that the player is caused to recognize an event that can be carried out, that is, existence of an event that the player has reserved. The configuration to inform the player of the registered event is not limited particularly. However, it is preferable that it is a configuration in which the player can recognize the number of registered events.

The deleting section 25 has a function to delete registration of the event carried out by the executing section 23.

Here, the “event carried out (that is, event that has been carried out)” may be an event that is cleared by the player or an event that is played by the player (containing an uncleared event. Further, the configuration to delete registration is not limited particularly.

FIG. 11 is a flowchart showing an example of the game processing carried out by the terminal 20. Hereinafter, an operation of the terminal 20D will be described as an example. In this regard, an operation of the terminal 20D with the server 10 is omitted from a point of view to avoid repeated explanation.

When a predetermined informing condition is satisfied, the terminal 20D informs the player of the registered event (Step S4-11). In the present embodiment, the terminal 20D refers to the predetermined storage region to cause a display device to display a game screen for causing the player to recognize the event that is registered as the reserved event (hereinafter, referred to as a “registration event informing screen”).

When the player is informed of the registered event, the terminal 20D delete the event that has been carried out (Step S4-12). In the present embodiment, the terminal 20D carries out processing to receive selection of an event from the player after the registration event informing screen is displayed, and to carry out the event selected by the player. The terminal 20D then deletes the event that has been carried out from the predetermined storage region.

As explained above, as one side of the fourth embodiment, the user terminal 20D is configured so as to include the informing section 24 and the deleting section 25. Thus, in a case where the number of registered events is a predetermined number, the user terminal 20D informs the player of at least one event of the predetermined number of events, and deletes registration of the event that was carried out. Therefore, it is possible to prevent the event from being left while being reserved.

### Fifth Embodiment

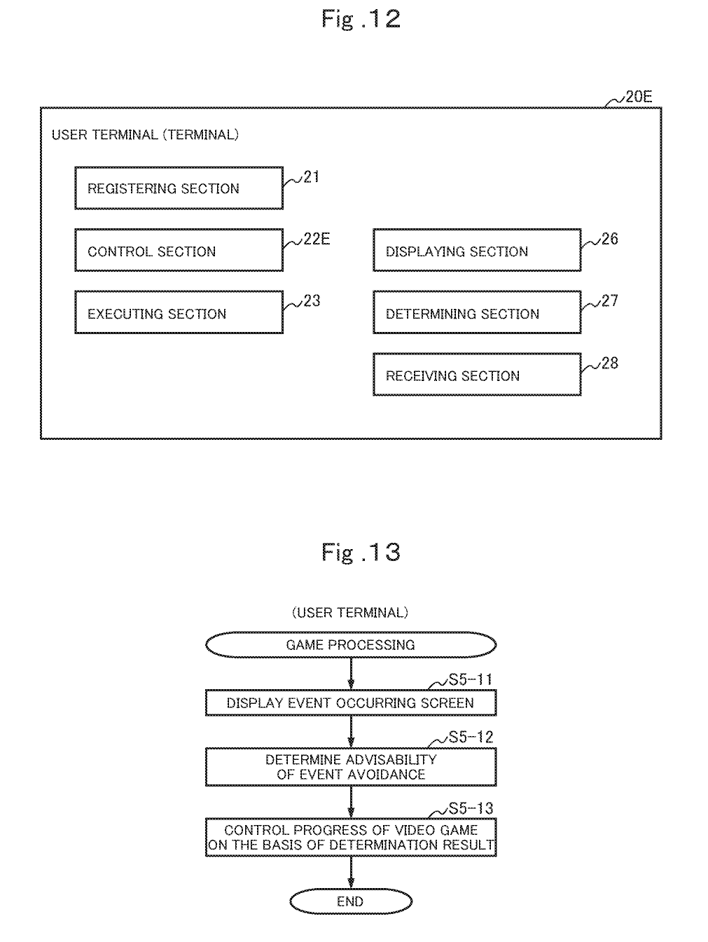

FIG. 12 is a block diagram showing a configuration of a user terminal 20E (hereinafter, referred to as a “terminal 20E”), which is an example of the user terminal 20. In the present embodiment, the terminal 20E at least includes a registering section 21, a control section 22E, an executing section 23, a displaying section 26, a determining section 27, and a receiving section 28.

The displaying section 26 has a function to display a game screen for receiving any of an execution request, a reserving request, and an avoidance request with respect to an event (hereinafter, referred to as an “event occurring screen”).

Here, the execution request for the event means a command to request to carry out an event that occurred. Further, the reserving request for the event means a command to request to register the event that occurred in a predetermined storage region. Further, the avoidance request for the event means a command to request to avoid the event that occurred.

The determining section 27 has a function to determine, when an avoidance request is received via the game screen, whether the event can be avoided or not in accordance with a predetermined determination rule.

Here, the phrase “receive an avoidance request via a game screen” means that a predetermined operation (for example, an operation to select an avoidance button included in the event occurring screen (not shown in the drawings)) is received when the game screen is displayed.

Further, the content of the determination rule is not limited particularly. However, it is preferable that it is one in which there is a probability to fail avoidance of an event. As an example of the determination rule, there is one in which success or failure is determined using an avoidance probability corresponding to the event.

The control section 22E has a function to control progress of the video game on the basis of a determination result by the determining section 27.

Here, the phase “control progress of the video game on the basis of the determination result” means that the determination result is reflected to progress of the video game. The configuration to reflect the determination result to progress of the video game is not limited particularly. However, it is preferable that it is a configuration in which the player can recognize that the determination result is reflected. As an example of such a configuration, there is a configuration in which progress of the video game is controlled thereafter as the event is avoided in a case where the determination result is succeeded, and the processing to carry out the event is carried out in a case where the determination result is failed.

The receiving section 28 has a function to receive a reserving request only in a case where an event that occurs in the video game satisfies a predetermined condition.

Here, the content of the predetermined condition is not limited particularly. However, it is preferable that it is one for which an influence on progress of the video game is considered.

FIG. 13 is a flowchart showing an example of the game processing carried out by the terminal 20. Hereinafter, an operation of the terminal 20E will be described as an example. In this regard, an operation of the terminal 20E with the server is omitted from a point of view to avoid repeated explanation.

The terminal 20E causes a display device to display the event occurring screen in a case where the event occurred (Step S5-11). In the present embodiment, the terminal 20E causes the display device to display, as the event occurring screen, a game screen that includes an image regarding the event that occurred, an event start operation receiving button, an event reserve operation receiving button, and an event avoidance operation receiving button.

When the event occurring screen is displayed and the avoidance request is then received, the terminal 20E determines whether the event can be avoided or not (Step S5-12). In the present embodiment, the terminal 20E determines advisability of event avoidance on the basis of a probability for the event. In this regard, the terminal 20E causes the display device to display the event occurring screen, and then carries out processing corresponding to each of the requests in a case where an execution request or a reserving request for the event is received.

When the advisability of the event avoidance is determined, the terminal 20E controls progress of the video game on the basis of a determination result (Step S5-13). In the present embodiment, in a case where the event avoidance is succeeded, the terminal 20E carries out processing corresponding to the event avoidance, and controls progress of the video game thereafter. Further, in a case where the event avoidance is failed, the terminal 20E carries out the event.

As explained above, as one side of the fifth embodiment, the user terminal 20E is configured so as to include the control section 22E, the displaying′section 26, and the determining section 27. Thus, the game screen for receiving any of the execution request for the event, the reserving request, and the avoidance request is displayed; when the avoidance request is received via the game screen, it is determined whether the event can be avoided or not in accordance with the predetermined determination rule; and progress of the video game is controlled on the basis of the determination result. Therefore, it is possible to give a characteristic to reserve the event that occurred, and this makes it possible to improve interest in the video game. Namely, for example, there has conventionally been a video game in which in a case where the event that occurred is a fight against an enemy character, the player is caused to select fight or avoidance. However, it is possible to provide characteristic choices, that is, “reserve” as different choices from the both selections.

Further, as one side of the fifth embodiment, the user terminal 20E is configured so as to include the receiving section 28. Thus, the reserving request is received only in a case where the event that occurred in the video game satisfies the predetermined condition. Therefore, it is possible to prevent game balance from being lost.

### Sixth Embodiment

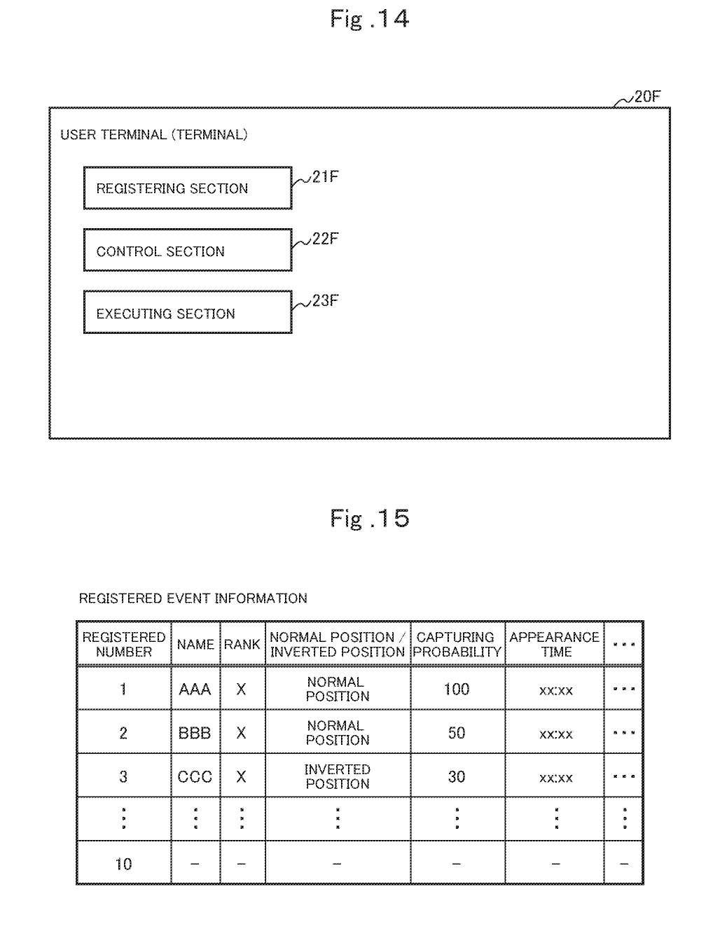

FIG. 14 is a block diagram showing a configuration of a user terminal 20F (hereinafter, referred to as a “terminal 20F”), which is an example of the user terminal 20 in the system 100 (see FIG. 1). Hereinafter, the case where progress of a video game (a so-called network game) that proceeds in the terminal 20F provided with a display device by appropriately communicating with a server 10 is controlled will be described as an example.

In the present embodiment, the terminal 20F at least includes a registering section 21F, a control section 22F, and an executing section 23F.

The registering section 21F has a function to register an event in a predetermined storage region when a reserving request for an event that occurred in the video game is received. In the present embodiment, the registering section 21F determines that a reserving request is received in a case where a specific virtual button provided in a game screen representing that a battle occurs when the battle against an enemy character occurs (hereinafter, referred to as an “event occurring screen”) is selected. The registering section 21F then registers information regarding this battle in a predetermined storage region in a reproducible state.

FIG. 15 is an explanatory drawing for explaining an example of a storage state of information stored in a storage section (not shown in the drawings) provided in the terminal 20F. As shown in FIG. 15, the terminal 20F stores, in the storage section, information regarding the registered event (registered event information), which contains a registered number, a name, a rank, a normal position or an inverted position, a capturing probability, and an appearance time.

Here, the registered number means an identification number of a registered event. In the present embodiment, a number is assigned to each of events in a registration order. Further, in the present embodiment, an upper limit is set up to a registerable number. In this regard, a method of naming the registered number and a change rule for the upper limit number are not limited particularly.

Further, the name plays a role as identification information of the event. The configuration to name a registered event is not limited particularly. However, it is preferable that it is a configuration in which a player can identify an event. In the present embodiment, a name of the enemy character is stored.

Further, the rank is information linked to an ID of the enemy character. In addition to the rank, information regarding the enemy character may be stored as information to be outputted when the registered event is carried out. In this regard, the terminal 20F may be configured so that the rank of the enemy character is determined on the basis of information regarding the player (for example, a level of the player).

Further, a normal position or an inverted position, a capturing probability, and the appearance time are information that is determined with an event unit. In addition to these, information regarding an event occurrence status may be stored as information that is to be reproduced when the event is carried out.

Here, the inverted position means one kind of a parameter correction for the enemy character, which is determined with a battle unit. The inverted position is held only during the battle, and an effect thereof never remain after the battle. The condition to become the inverted position is not limited particularly. However, in the present embodiment, a condition using the level of the player and a probability that can specified in accordance with a predetermined rule is provided. In this regard, in the present embodiment, in case of the inverted position, it expresses an “inverted position” in order to represent a state that “a screen is rotated by a half to cause the screen to be reversed after an enemy arrives at a fixed position in the screen”.

Further, the capturing probability means a probability that the player can capture an enemy character. The configuration to calculate the capturing probability is not limited particularly. However, it is preferable that it is a configuration in which the player can change the capturing probability by using an in-game element.

Further, the appearance time means a time when the enemy character appears. A method of utilizing the appearance time is not limited particularly. However, the terminal 20F may be configured so as to present the appearance time to the player as a record. Alternatively, the terminal 20F may be configured so as to update or delete the information regarding the battle when a predetermined time elapses since the appearance time.

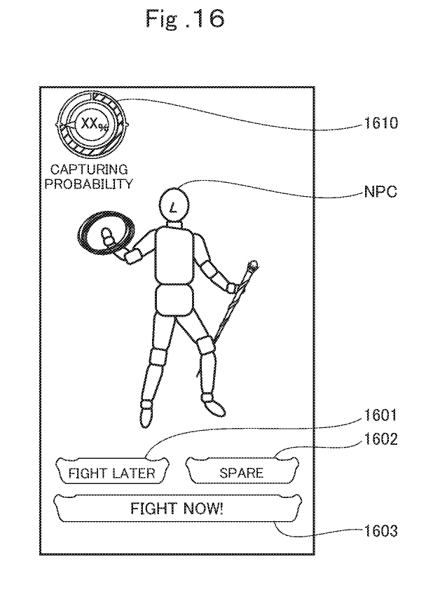

FIG. 16 is an explanatory drawing for explaining an example of a game screen. As shown in FIG. 16, an enemy character NPC, a reserve button 1601, an event avoidance button 1602, an event execution button 1603, and a capturing probability display region 1610 are provided in a game screen as an event occurring screen.

The reserve button 1601 is a virtual button for receiving a reserving request from the player. When the player selects the button, a battle against the enemy character NPC is registered, and the video game proceeds to a next scene without carrying out a battle.

The event avoidance button 1602 is a virtual button for receiving an avoidance request from the player. When the player selects the button, avoidance determination for the battle against the enemy character NPC is carried out, and the battle is avoided, or the battle is carried out by means of avoidance failure.

The event execution button 1603 is a virtual button for receiving an execution request by the player. When the player selects the button, a battle against the enemy character NPC is carried out.

The control section 22F has a function to control progress of the video game on the basis of a situation that an event is registered. In the present embodiment, when a battle is registered as an event, the control section 22F carries out the processing thereafter as the battle is terminated by means of registration. In this regard, the terminal 20F may be configured so that with respect to the registered battle the registration is reflected to the processing thereafter. Alternatively, the terminal 20F may be configured so that the registration is treated as a situation that the battle has not occurred.

The executing section 23F has a function to carry out an event registered in a predetermined storage region when an execution request for the event is receives. In the present embodiment, the executing section 23F carries out the battle when the registered battle is selected by the player. In this regard, in the present embodiment, a list of the register battles is displayed in response to a player operation, and a battle selected by the player is carried out.

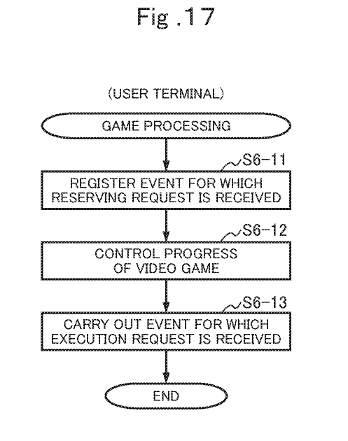

FIG. 17 is a flowchart showing an example of processing regarding the video game (the game processing) carried out by the terminal 20F. Hereinafter, an operation of the terminal 20F will be described as an example. In this regard, an operation of the terminal 20F with the server 10 is omitted from a point of view to avoid repeated explanation.

In the game processing, the terminal 20F first registers an event for which a reserving request is received (Step S6-11). In the present embodiment, in a case where a battle occurs as the event and a reserving request is received from the player, the terminal 20F registers the battle in the predetermined storage region.

When the event is registered, the terminal 20F controls progress of the video game thereafter (Step S6-12). In the present embodiment, the terminal 20F carries out the processing corresponding to a situation that the registered battle is reserved, thereby controlling progress of the video game thereafter.

When an execution request for the registered event is received while controlling progress of the video game, the terminal 20F carries out the event for which the execution request is received (Step S6-13). In the present embodiment, the terminal 20F starts a battle selected by the player among the registered battles.

As explained above, as one side of the sixth embodiment, the user terminal 20F provided with the functions to control progress of the video game in response to an operation of the user is configured so as to include the registering section 21F, the control section 22F, and the executing section 23F. Thus, when the reserving request for the event that occurred in the video game is received, the event is registered in the predetermined storage region; progress of the video game is controlled on the basis of the situation that the event was registered; and the event is carried out when the execution request for the event registered in the predetermined storage region is received. Therefore, it is possible to improve the degree of freedom regarding how to enjoy a video game.

In this regard, as one side of the sixth embodiment, the user terminal 20F may be configured so as to cause the player to carry out a test and determine an enemy character on the basis of a result of the test. By configuring the user terminal 20F in this manner, it is possible to improve interest in the test in the video game. In this case, the configuration of the test is not limited particularly. However, it is preferable that it is a configuration in which the player sets the in-game element to a given choice. As an example of such a configuration, there is a configuration in which a side of asking a question (for example, an administrator side of the video game) creates a question regarding a real event and a plurality of choices, a player is caused to select a predetermined number of choices, and a privilege is given to the player who selected a choice corresponding to a correct answer after the correct answer is decided. In this regard, in this case, the user terminal 20F may also be configured so that the player who selects an incorrect answer is caused to carry out a battle against an enemy character, and the player determines dealing of an in-game element set to the choice on the basis of a result of the battle. Namely, for example, the user terminal 20F may also be configured so that, in a case where even a player who selected the incorrect answer wins a subsequent battle against the enemy character, the player can obtain a part or all of a plurality of in-game elements respectively set to the incorrect answers. Moreover, the user terminal 20F may be configured so that such a battle can be reserved.

In this regard, as one side of the sixth embodiment, the user terminal 20F may be configured so that the event occurring screen corresponding to the battle is displayed when the execution request for the registered battle is received. By configuring the user terminal 20F in such a manner, it is possible to eliminate a load to generate a new screen.

In this regard, as one side of the sixth embodiment, the user terminal 20F may be configured so as to adopt, with respect to a status of the player or the player character when the reserved event is carried out, the status when the event occurs, or adopt the status when the event is carried out. Alternatively, the user terminal 20F may be configured so that the status when the event occurs is normally adopted and the status when the event is carried out is adopted when a predetermined condition is satisfied, for example, when a predetermined in-game element is used by the player.

In this regard, as one side of the sixth embodiment, the user terminal 20F may be configured so as to encourage cooperation of a plurality of players. In this case, the user terminal 20F may be configured so that the player is allowed to act without consuming his or her assets in the video game in a case where a predetermined condition regarding other player is satisfied in the video game. For example, when one of choices is selected in a quiz game, an in-game element of the player is normally consumed as a cost. However, in this case, the terminal 20F may be configured there is no cost for the choice selected by other player until a predetermined number of times. Further, the user terminal 20F may be configured so that, in a case where other player attacks an enemy character that the other player encounters, the player is not required to pay the cost for the attack, which the player is normally required, until the predetermined number of times. In this regard, the user terminal 20F may be configured so that, in a case where this battle against the enemy character is reserved by other player, the other player carries out the battle and then, the player is informed of that effect (that is, a fact that the other player starts to carryout the reserved battle).

As explained above, one or two or more shortages can be solved by each of the embodiments of the present application. In this regard, the effects according to each of the embodiments are non-limiting effects or one example of the non-limiting effects.

In this regard, in each of the embodiments described above, each of the plurality of user terminals 20 and 201 to 20N and the server 10 carries out the various kinds of processing described above in accordance with various kinds of control programs (for example, a video game processing program) stored in the storage device with which the corresponding terminal or server is provided.

Further, a configuration of the system 100 is limited to the configuration that has been explained as an example of each of the embodiments described above. For example, the system 100 may be configured so that part or all of the processing that has been explained as the processing carried out by the user terminal is carried out by the server 10, or it may be configured so that part or all of the processing that has been explained as the processing carried out by the server 10 is carried out by any of the plurality of user terminals 20 and 201 to 20N (for example, the user terminal 20). Further, the system 100 may be configured so that a part or all of the storing sections included by the server 10 is included in any of the plurality of user terminals 20 and 201 to 20N. Namely, the system 100 may be configured so that a part or all of the functions included in any one of the user terminal 20 and the server 10 according to the system 100 is included in the other.

Further, the program may be configured so as to cause a single apparatus that does not include a communication network to realize a part or all of the functions that have been explained as the examples of the respective embodiments described above.

In this regard, the word “in accordance with progress of the video game” means that occurrence of various kinds of progress or changes and the like that can be generated in the video game becomes timing or a standard of a specific process. As examples of the specific process, there are a determining process, an information updating process, and the like. Further, as examples of the various kinds of progress or changes that can be generated in the video game, there are progress of time, a change in a game element value, a specific status or update of a flag, an operation input by the user, and the like.

(Appendix)

The explanation of the embodiments described above has been described so that the following inventions can be at least realized by a person having a normal skill in the art to which the present invention belongs.

(1)

A non-transitory computer-readable medium including a video game processing program product for causing a user terminal to realize functions to control progress of a video game in response to an operation of a user,

wherein the functions include:

a registering function configured to register an event in a predetermined storage region when a reserving request for the event is received, the event occurring in the video game;

a controlling function configured to control the progress of the video game in a case where the event is registered; and

an executing function configured to carry out the event when an execution request for the event registered in the predetermined storage region is received.

(2)

The non-transitory computer-readable medium according to claim 1),
wherein the controlling function includes a function configured to control the progress of the video game as the registered event did not occur or the event was terminated.
   (3)

The non-transitory computer-readable medium according to claim 1) or (2),

wherein the registering function includes a function configured to register the event and predetermined information in the predetermined storage region so as to be associated with each other, and

wherein the executing function includes a function configured to carry out the event on the basis of the execution request, the execution request being received via a list to be displayed by referring to the predetermined storage region.

(4)

The non-transitory computer-readable medium according to any one of claims 1) to (3),

wherein the functions further include:

an informing function configured to inform, in a case where there are a predetermined number of the registered events, a player of at least one event of the predetermined number of events; and

a deleting function configured to delete registration of the event carried out by the executing function.

(5)

The non-transitory computer-readable medium according to any one of claims 1) to (4),

wherein the functions further include:

a displaying function configured to display a game screen for receiving any of the execution request for the event, the reserving request, and an avoidance request; and

a determining function configured to determine whether the event can be avoided or not in accordance with a predetermined determination rule when the avoidance request is received via the game screen, and

wherein the controlling function includes a function configured to control the progress of the video game on the basis of a determination result by the determining function.

(6)

The non-transitory computer-readable medium according to any one of claims 1) to (5),

wherein the functions further include:

a receiving function configured to receive the reserving request only in a case where the event that occurs in the video game satisfies a predetermined condition.

(7)

A non-transitory computer-readable medium including a video game processing program for causing a server to realize at least one function of the functions that the video game processing program product described in any one of claims 1) to (6) causes the user terminal to realize, the server being capable of communicating with the user terminal.

(8)

A user terminal into which the video game processing program product included in the non-transitory computer-readable medium according to any one of claims 1) to (7) is installed.

(9)

A video game processing system for controlling progress of a video game in response to an operation of a user, the video game processing system including a communication network, a server, and a user terminal, the video game processing system comprising:

a registering section configured to register an event in a predetermined storage region when a reserving request for the event is received, the event occurring in the video game;

a controlling section configured to control the progress of the video game in a case where the event is registered; and

an executing section configured to carry out the event when an execution request for the event registered in the predetermined storage region is received.

(10)

The video game processing system according to claim 9),

wherein the server includes the registering section, the controlling section, and the executing section, and

wherein the user terminal includes:

a receiving section configured to receive information for outputting the video game on a display screen of a display device.

(11)

A non-transitory computer-readable medium including a video game processing program for causing a server to realize functions to control progress of a video game in response to an operation of a user,

wherein the functions include:

a registering function configured to register an event in a predetermined storage region when a reserving request for the event is received, the event occurring in the video game;

a controlling function configured to control progress of the video game in a case where the event is registered; and

an executing function configured to carry out the event when an execution request for the event registered in the predetermined storage region is received.

(12)

A non-transitory computer-readable medium including a video game processing program product for causing a user terminal to realize functions to control progress of a video game in response to an operation of a user,

wherein a server includes:

a registering function configured to register an event in a predetermined storage region when a reserving request for the event is received, the event occurring in the video game;

a controlling function configured to control the progress of the video game in a case where the event is registered; and

an executing function configured to carry out the event when an execution request for the event registered in the predetermined storage region is received, and

wherein the functions include:

a receiving function configured to receive, from the server, information for outputting the video game on a display screen of a display device.

(13)

A non-transitory computer-readable medium including a video game processing program product for causing a user terminal to realize at least one function of the functions that the video game processing program product included in the non-transitory computer-readable medium according to claim (11) causes the server to realize, the user terminal being capable of communicating with the server.

(14)

A server into which the video game processing program included in the non-transitory computer-readable medium according to claim 11) or (13) is installed.

(15)

A video game processing method for controlling progress of a video game in response to an operation of a user, the video game processing method comprising:

a registering process configured to register an event in a predetermined storage region when a reserving request for the event is received, the event occurring in the video game;

a controlling process configured to control the progress of the video game in a case where the event is registered; and

an executing process configured to carry out the event when an execution request for the event registered in the predetermined storage region is received.

(16)

A video game processing method carried out by a video game processing system for controlling progress of a video game in response to an operation of a user, the video game processing system comprising a communication network, a server, and a user terminal, the video game processing method comprising:

a registering process configured to register an event in a predetermined storage region when a reserving request for the event is received, the event occurring in the video game;

a controlling process configured to control the progress of the video game in a case where the event is registered; and

an executing process configured to carry out the event when an execution request for the event registered in the predetermined storage region is received.

According to one of the embodiments of the present invention, it is useful to improve the degree of freedom regarding how to enjoy a video game.

What is claimed is:

1. A non-transitory computer-readable medium including a video game processing program product for causing a user terminal to realize functions to control progress of a video game in response to an operation of a user,
wherein the functions include:
a registering function configured to register an event in a predetermined storage region when a reserving request for the event is received, the event occurring in the video game;
a controlling function configured to control the progress of the video game in a case where the event is registered; and
an executing function configured to carry out the event when an execution request for the event registered in the predetermined storage region is received.

2. The non-transitory computer-readable medium according to claim 1,
wherein the controlling function includes a function configured to control the progress of the video game as the registered event did not occur or the event was terminated.

3. The non-transitory computer-readable medium according to claim 1,
wherein the registering function includes a function configured to register the event and predetermined information in the predetermined storage region so as to be associated with each other, and
wherein the executing function includes a function configured to carry out the event on the basis of the execution request, the execution request being received via a list to be displayed by referring to the predetermined storage region.

4. The non-transitory computer-readable medium according to claim 1,
wherein the functions further include:
an informing function configured to inform, in a case where there are a predetermined number of the registered events, a player of at least one event of the predetermined number of events; and
a deleting function configured to delete registration of the event carried out by the executing function.

5. The non-transitory computer-readable medium according to claim 1,
wherein the functions further include:
a displaying function configured to display a game screen for receiving any of the execution request for the event, the reserving request, and an avoidance request; and
a determining function configured to determine whether the event can be avoided or not in accordance with a predetermined determination rule when the avoidance request is received via the game screen, and
wherein the controlling function includes a function configured to control the progress of the video game on the basis of a determination result by the determining function.

6. The non-transitory computer-readable medium according to claim 1,
wherein the functions further include:
a receiving function configured to receive the reserving request only in a case where the event that occurs in the video game satisfies a predetermined condition.

7. A non-transitory computer-readable medium including a video game processing program for causing a server to realize at least one function of the functions that the video game processing program product described in claim 1 causes the user terminal to realize, the server being capable of communicating with the user terminal.

8. A user terminal into which the video game processing program product included in the non-transitory computer-readable medium according to claim 1 is installed.

9. A non-transitory computer-readable medium including a video game processing program for causing a server to realize functions to control progress of a video game in response to an operation of a user,
wherein the functions include:
a registering function configured to register an event in a predetermined storage region when a reserving request for the event is received, the event occurring in the video game;
a controlling function configured to control progress of the video game in a case where the event is registered; and
an executing function configured to carry out the event when an execution request for the event registered in the predetermined storage region is received.

10. A video game processing system for controlling progress of a video game in response to an operation of a user, the video game processing system including a communication network, a server, and a user terminal, the video game processing system comprising:
a registering section configured to register an event in a predetermined storage region when a reserving request for the event is received, the event occurring in the video game;
a controlling section configured to control the progress of the video game in a case where the event is registered; and
an executing section configured to carry out the event when an execution request for the event registered in the predetermined storage region is received.
